(19) United States
(12) Patent Application Publication
(10) Pub. No.: US 2025/0007395 A1
(43) Pub. Date: Jan. 2, 2025

(54) MULTI-MODE VOLTAGE REGULATOR VOLTAGE FEEDBACK LOOP

(71) Applicant: Intel Corporation, Santa Clara, CA (US)

(72) Inventors: Keng Chen, Acton, MA (US); Arvind Raghavan, Lexington, MA (US); Rachid Rayess, Hudson, MA (US); Tamir Salus, Zichron Yaakov (IL); Christopher Schaef, Hillsboro, OR (US); Huanhuan Zhang, Ashland, MA (US); Sivaraman Masilamani, Northborough, MA (US); Gayathri Devi Sridharan, Northborough, MA (US); Subhrashankha Ghosh, Beaverton, OR (US)

(21) Appl. No.: 18/216,940

(22) Filed: Jun. 30, 2023

(51) Int. Cl. H02M 3/07; G05F 1/575; H02M 1/00

(52) U.S. Cl. CPC H02M 3/07; G05F 1/575; H02M 1/0003

(57) ABSTRACT

A switched capacitor voltage regulator (SCVR) design, such as a continuous capacitive voltage regulator (C2VR) design, may use capacitors and switches to provide improved cost and space efficiencies. A remote sensing circuit may be used to improve C2VR performance. By adding a remote sensing circuit to the regulation feedback loop within the C2VR circuit design, the C2VR circuit may provide improved accuracy in voltage regulation, such as by providing a correction based on the voltage error between the remote-sensed voltage and the reference target. The remote sensing circuit may also provide transient information for under-voltage detection at an output terminal. This detected transient may become an alternating current (AC) portion of the under-voltage detection threshold, which improves the ability of the C2VR circuit to provide early detection for any under-voltage fault.

### TECHNICAL FIELD

Embodiments described herein generally relate to power management for electronic devices.

### BACKGROUND

In modern semiconductor devices and System on a Chip (SoC) design, voltage regulators may be used to provide a substantially constant voltage to various integrated circuits (ICs) or other semiconductor components. A voltage regulator may use a feedback mechanism to maintain the substantially constant voltage.

A switched capacitor voltage regulator (SCVR) design, such as a continuous capacitive voltage regulator (C2VR) design, may use capacitors and switches to provide improved cost and space efficiencies. A C2VR converter may use a single-ended feedback sensing circuit, which may face an accuracy challenge in the closed loop regulation. For a given SoC design, a C2VR converter may be placed relatively far from a load, and the power delivery routing distance may cause a large current-resistance (IR) voltage drop. In some designs, an increase in the current load may result in a corresponding output voltage drops. Additionally, due to voltage ripple variation in various C2VR operation modes (e.g., turbo mode, dynamic maximum frequency (fmax), it may be difficult for the C2VR to provide accurate voltage levels across various modes.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a C2VR digital feedback loop architecture 100, according to an embodiment.

FIG. 2 is a block diagram illustrating a C2VR mixed signal feedback loop architecture 200, according to an embodiment.

FIG. 3A is a block diagram illustrating a ping-pong FSM control circuitry 300, according to an embodiment.

FIG. 3B is a block diagram illustrating ping-pong FSM control timing 301, according to an embodiment.

FIG. 4A is a flow diagram illustrating frequency-based tuning 400, according to an embodiment.

FIG. 4B is a flow diagram illustrating duty cycle-based tuning 401, according to an embodiment.

FIG. 5 is a diagram illustrating non-dithered output voltage waveforms 500, according to an embodiment.

FIG. 6 is a diagram illustrating dithered output voltage waveforms 600, according to an embodiment.

FIG. 7 is a diagram illustrating under-voltage trigger detection waveforms 700, according to an embodiment.

FIG. 8 is a block diagram illustrating a C2VR analog feedback loop architecture 800, according to an embodiment.

FIG. 9 is a block diagram illustrating a C2VR pulse count feedback loop architecture 900, according to an embodiment.

FIG. 10 is a flowchart illustrating a voltage regulation method 1000, according to an embodiment.

FIG. 11 is a block diagram of a computing device 1100 employing parallel current source voltage regulation, according to an embodiment.

### DETAILED DESCRIPTION

A remote sensing circuit may be used to improve C2VR performance. By adding a remote sensing circuit to the regulation feedback loop within the C2VR circuit design, the C2VR circuit may provide improved accuracy in voltage regulation, such as by providing a correction based on the voltage error between the remote-sensed voltage and the reference target. The remote sensing circuit may also provide transient information for under-voltage detection at an output terminal. This detected transient may become an alternating current (AC) portion of the under-voltage detection threshold, which improves the ability of the C2VR circuit to provide early detection for any under-voltage fault.

In the following description, for purposes of explanation, numerous specific details are set forth to provide a thorough understanding of some example embodiments. It will be evident, however, to one skilled in the art that the present disclosure may be practiced without these specific details.

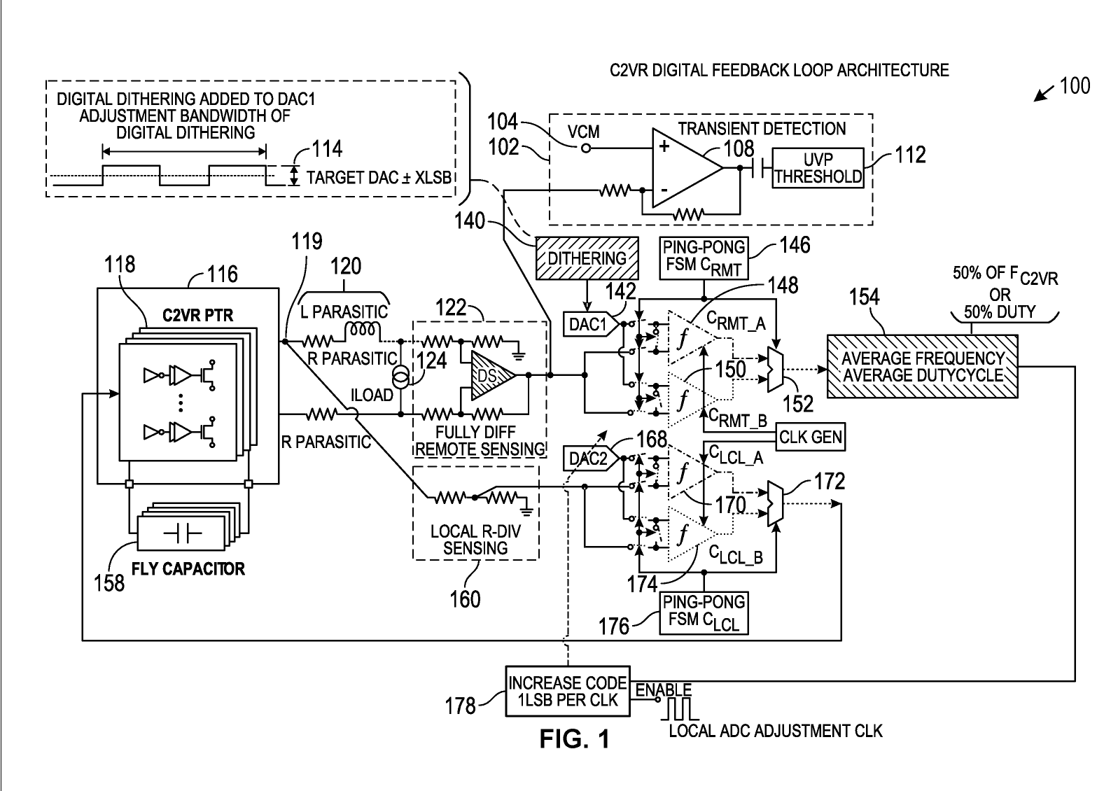

FIG. 1 is a block diagram illustrating a C2VR digital feedback loop regulator architecture 100, according to an embodiment. The C2VR digital feedback loop architecture 100 may include multiple C2VR circuits 118 arranged in a power train (PTR) circuit, such as C2VR PTR 116, which is coupled to a fly capacitor array 158. The C2VR digital feedback loop architecture 100 includes both a remote voltage sensing circuit 122 and a local voltage sensing circuit 160. As used herein, “local” voltage sensing refers to sensing voltage at the remote voltage sensing circuit 122 from a local voltage pickoff location 119 between the C2VR PTR 116 and the load 124. In an example, this local voltage pickoff location 119 is between the C2VR PTR 116 and any parasitic resistance and capacitance 120 attached to the load 124. As used herein, “remote” voltage sensing refers to differential voltage sensing at the remote voltage sensing circuit 160 based on voltage pickoffs on either side of the load 124.

The C2VR digital feedback loop architecture 100 includes a first pair of feedback comparators 148 and 150 coupled to the remote voltage sensing circuit 122. A digital to analog converter (DAC) such as remote DAC 142 is also coupled to the first pair of feedback comparators 148 and 150. The outputs of the remote voltage sensing circuit 122 and the remote DAC 142 are coupled alternatingly to either of the first pair of feedback comparators 148 and 150 using a first comparator controller circuit 146 and a first comparator multiplexer 152. In an example, the remote voltage sensing circuit 122 and the remote DAC 142 are initially coupled to feedback comparator 148, subsequently coupled to feedback comparator 150, then back to feedback comparator 148, and so on. Similarly, the C2VR digital feedback loop architecture 100 includes a second pair of feedback comparators 170 and 174 coupled to the local voltage sensing circuit 160. The output of the local voltage sensing circuit 160 and an output of a local DAC 168 may be coupled alternatingly to the second pair of feedback comparators 170 and 174 using a second comparator controller circuit 176 and a second comparator multiplexer 172.

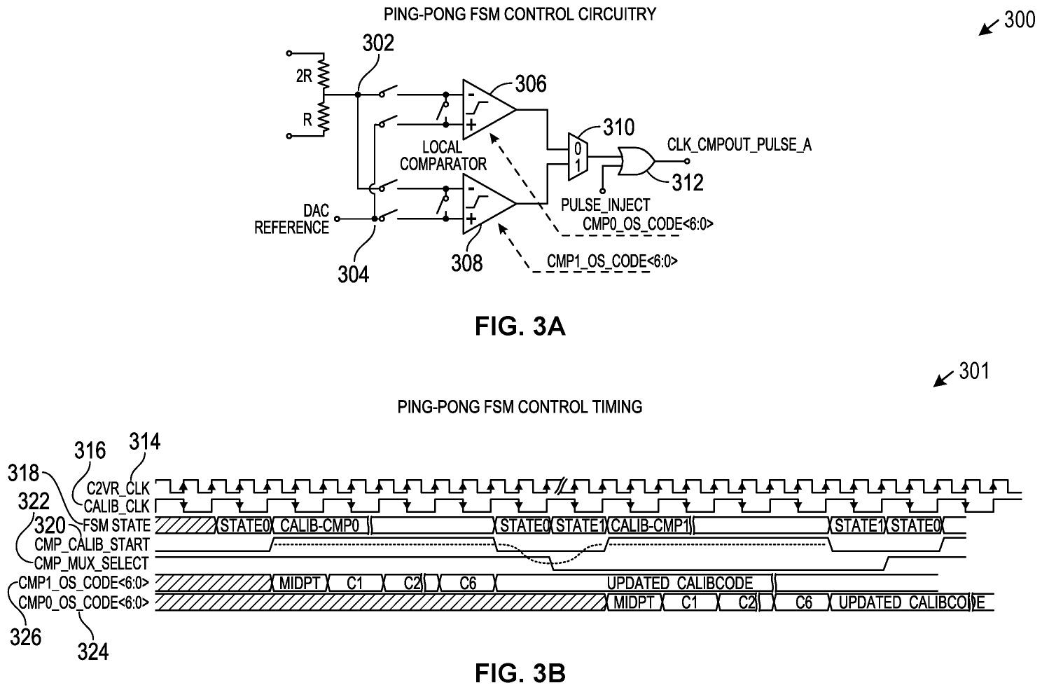

The first comparator controller circuit 146 and the second comparator controller circuit 176 may use an alternating “ping-pong” finite state machine (FSM) control method to switch between comparators. This comparator switching allows for calibrating the comparator that is not currently coupled to a sensing circuit. This alternating comparator calibration allows each pair of comparators to reduce or minimize adverse effects due to any input-referred offset voltage, thereby providing improved local and remote voltage regulation accuracy. The operation of the ping-pong FSM control method and circuitry is shown and described further with respect to FIG. 3A and FIG. 3B.

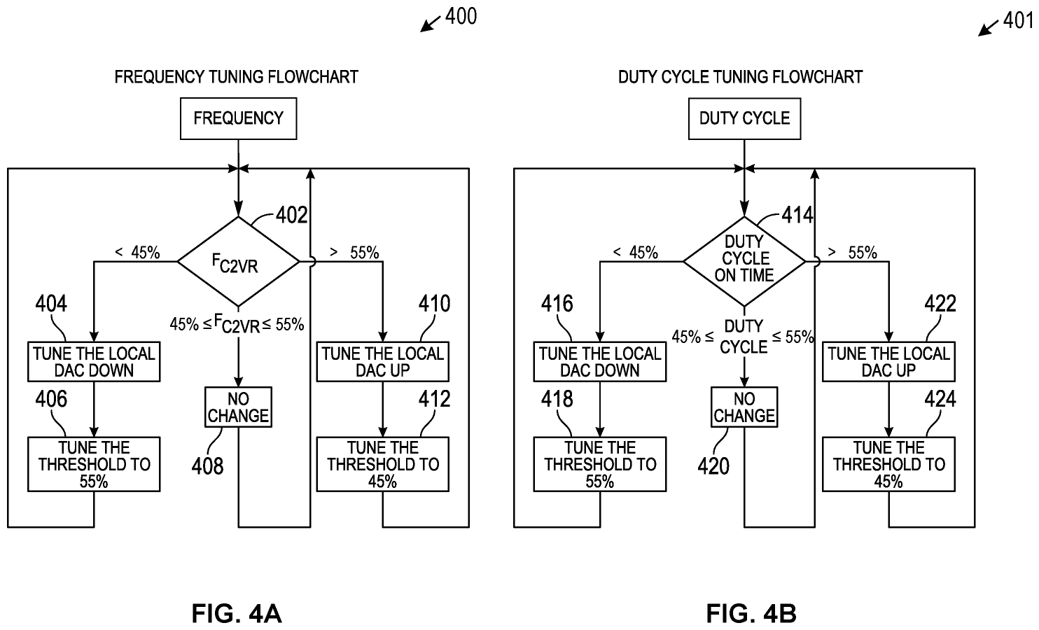

The C2VR digital feedback loop architecture 100 may include a digital tuning circuit 154, which is used to enable tuning of the local voltage sensing circuit 160 by tuning the local DAC 168. In operation, the multiplexed output from the remote voltage sensing circuit 122 is received at the digital tuning circuit 154, which applies either an average frequency threshold (e.g., 50% of the C2VR frequency) or average duty cycle. The output of the digital tuning circuit 154 is received at a DAC code circuit 178, which may be used to increase or decrease the code by one least significant bit (LSB) at the local DAC 168. The application of the average frequency threshold or average duty cycle is shown and described further with respect to FIG. 4A and FIG. 4B.

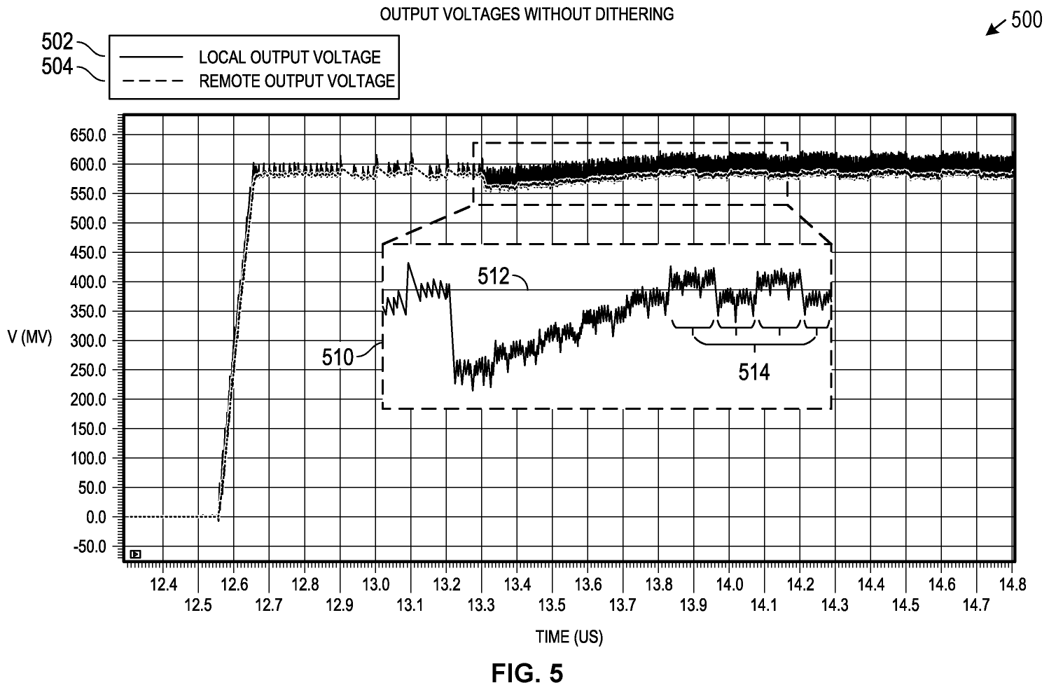

The C2VR digital feedback loop architecture 100 may include a dithering circuit 140 coupled to the remote DAC 142. The finite resolution of the local DAC 168 may affect the reference adjustments of the second pair of feedback comparators 170 and 174 and cause a one-LSB ripple at the output of the C2VR PTR 116, such as at voltage pickoff location 119. The dithering circuit 140 may be used to reduce or minimize this ripple effect to provide a reference to the remote DAC 142, where the reference is within one LSB of the target DAC 114. An example calibration algorithm for the dithering circuit 140 is shown and described further with respect to FIG. 5.

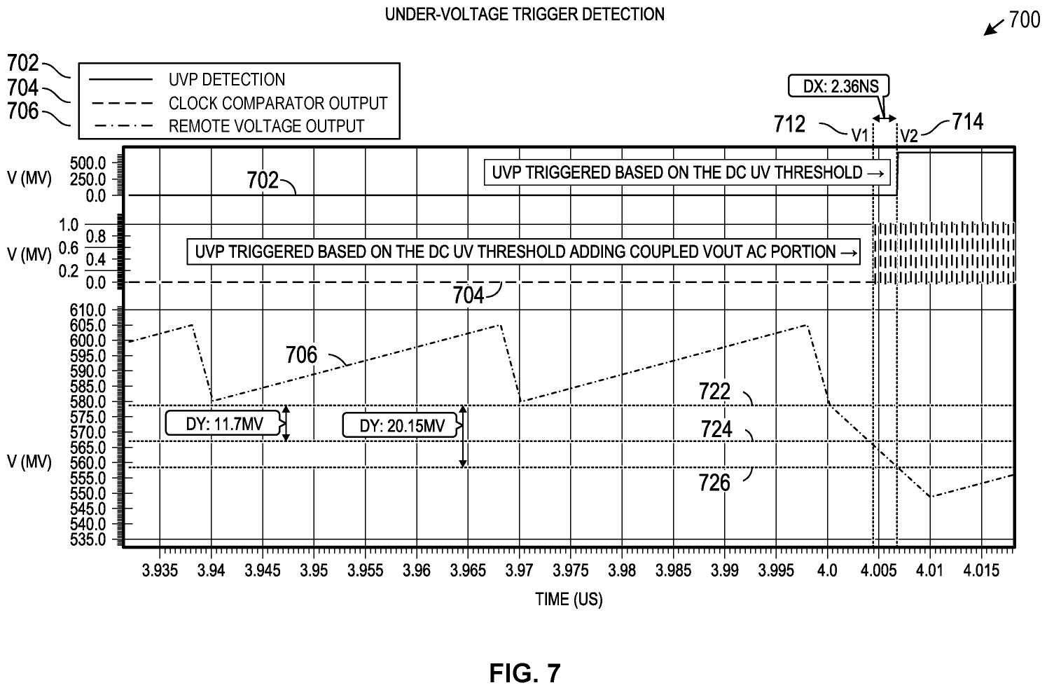

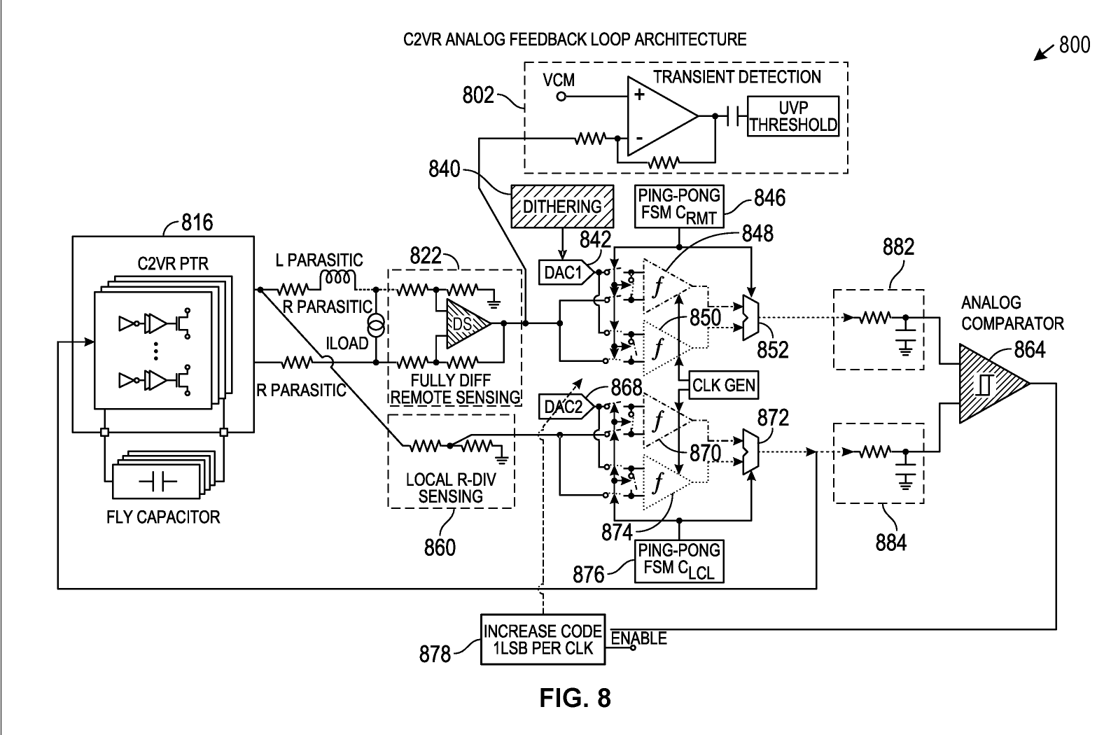

The C2VR digital feedback loop architecture 100 may include a transient detection circuit 102 coupled to the remote voltage sensing circuit 122. The transient detection circuit 102 may include a non-inverting amplifier 108 that amplifies the common mode voltage V_{CM} 104 with respect to the output of the remote voltage sensing circuit 122. The amplified output of the non-inverting amplifier 108 may be used in an underfrequency protection (UVP) threshold circuit 112 to provide improved (e.g., reduced time) detection and alert for any output voltage droop. An example of the improved voltage droop detection is shown and described further with respect to FIGS. 7 and 8.

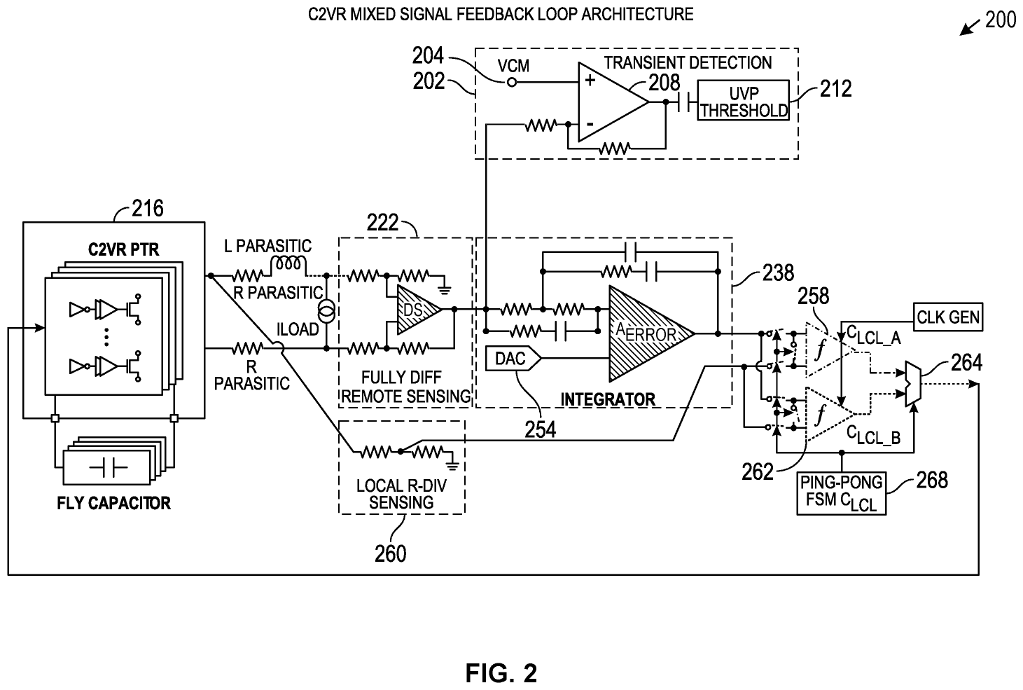

FIG. 2 is a block diagram illustrating a C2VR mixed signal feedback loop architecture 200, according to an embodiment. The C2VR mixed signal feedback loop architecture 200 shown in FIG. 2 may include a mixed digital signal and analog signal implementation corresponding to C2VR digital feedback loop architecture 100 shown in FIG. 1.

The C2VR mixed signal feedback loop architecture 200 includes a C2VR PTR 216 coupled to a remote voltage sensing circuit 222 and a local voltage sensing circuit 260. The C2VR mixed signal feedback loop architecture 200 includes an analog integrator 238 coupled to the remote voltage sensing circuit 222. The analog integrator 238 receives the output of the remote voltage sensing circuit 222 and an integrator DAC 254 and generates an integrated voltage signal output. The use of the analog integrator 238 avoids the need for a local DAC coupled to the local voltage sensing circuit 260, which avoids the need for a dithering circuit to reduce or minimize the one-LSB ripple effect at the C2VR PTR 216.

The C2VR digital loop regulator architecture 200 includes a first feedback comparator 258 and to a second feedback comparator 262. The outputs of the analog integrator 238 and the local voltage sensing circuit 260 are coupled alternatingly to either of the first feedback comparator 258 or the second feedback comparator 262 using a comparator controller circuit 268 and a comparator multiplexer 264. The comparator controller circuit 268 may use the alternating ping-pong FSM control method to switch between comparators, which allows for calibrating the comparator that is not currently coupled to a sensing circuit. This alternating comparator calibration allows each pair of comparators to reduce or minimize adverse effects due to any input-referred offset voltage, thereby providing improved local and remote voltage regulation accuracy. The operation of the ping-pong FSM control method and circuitry is shown and described further with respect to FIG. 3A and FIG. 3B.

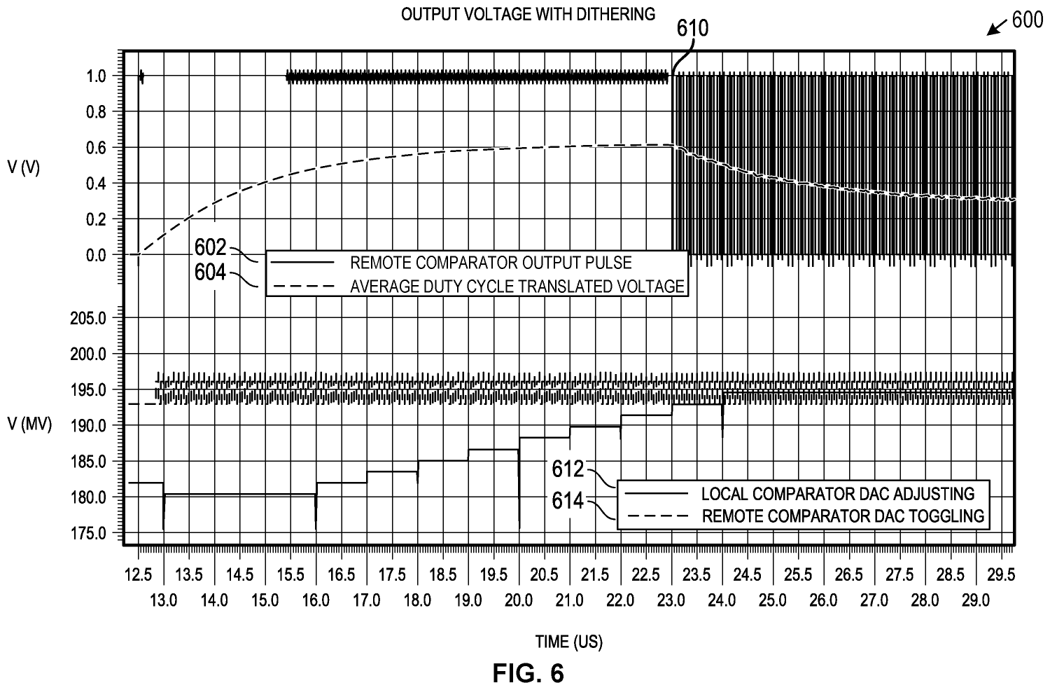

The C2VR digital loop regulator architecture 200 may include a transient detection circuit 202 coupled to the remote voltage sensing circuit 222. The transient detection circuit 202 may include a non-inverting amplifier 208 that amplifies the common mode voltage V_{CM} 204 with respect to the output of the remote voltage sensing circuit 222. The amplified output of the non-inverting amplifier 208 may be used in an underfrequency protection (UVP) threshold circuit 212 to provide improved detection and alert for any output voltage droop. An example of the improved voltage droop detection is shown and described further with respect to FIG. 6 and FIG. 7.

FIG. 3A is a block diagram illustrating a ping-pong FSM control circuitry 300, according to an embodiment. The ping-pong FSM control circuitry 300 includes a first comparator 306 and a second comparator 308. The comparators receive a first input at a first input node 302 from a sensing circuit or integrator circuit, and receive a second input at a second input node 304 from a DAC reference. The outputs of the comparators are multiplexed at a multiplexer 310, whose output is provided to a logical OR gate 312 to generate a ping-pong control circuit output signal.

FIG. 3B is a block diagram illustrating ping-pong FSM control timing 301, according to an embodiment. A C2VR clock signal 314 may run at twice the frequency of a calibration clock signal 316. The FSM state 318 indicates a current state of the ping-pong FSM. In an example, the FSM state 318 transitions from a state 0 to a calibration of the first comparator 306, then back to state 0, then to state 1, then to a calibration of the second comparator 308, then to state 1, then back to state 0, and so on. Each of the transitions in the FSM state 318 into and out of a calibration state are controlled by a comparator calibration start signal 320. A comparator multiplexer signal 322 is used to control the multiplexer 310, which switches its output to the comparator that is not being calibrated. A first comparator code calibration signal 324 and a second comparator code calibration signal 326 are used to provide code calibration signals C1-C6 during calibration to the first comparator 306 and the second comparator 308, respectively. In an example, the code calibration signals C1-C6 correspond to calibrated voltage levels that may be received from a DAC.

FIG. 4A is a flow diagram illustrating frequency-based tuning 400, according to an embodiment. The frequency-based tuning 400 may be used for tuning a digital tuning circuit, such as digital tuning circuit 154 shown in FIG. 1. The frequency-based tuning 400 may begin by determining whether an input C2VR frequency 402 is below 45% of a target frequency value. If the C2VR frequency 402 is below 45% of the target frequency value, the digital tuning circuit may generate a signal to tune the local DAC down 404 and tune the triggering frequency threshold 406 to 55%. Subsequently, the frequency-based tuning 400 determines whether the input C2VR frequency 402 is above 55% of a target frequency value. If the C2VR frequency 402 is above 55% of the target frequency value, the digital tuning circuit may generate a signal to tune the local DAC up 410 and tune the triggering frequency threshold 412 to 55%. If the C2VR frequency 402 does not exceed the frequency threshold, then no change is made 408 to either the DAC or to the threshold. The tuning of the frequency thresholds may be used to provide a frequency hysteresis, which allows for a digital tuning circuit to adjust a DAC to enable a stable C2VR voltage output while reducing or minimizing excess switching due to noise. While this frequency-based tuning 400 is described with respect to values of 45% and 55%, other levels of frequency adjustments may be used to provide a frequency hysteresis, such as increasing or decreasing the threshold by 1%, 2%, 10%, 20%, or other frequency increments. The frequency adjustment level may be selected based on an analysis of noise-induced fluctuations of the C2VR frequency or based on a desired C2VR output voltage level accuracy.

FIG. 4B is a flow diagram illustrating duty cycle-based tuning 401, according to an embodiment. The duty cycle-based tuning 401 may also be used for tuning a digital tuning circuit, such as digital tuning circuit 154 shown in FIG. 1. The duty cycle-based tuning 401 may begin by determining whether a current C2VR duty cycle 414 is below 45% of a target duty cycle value. If the C2VR duty cycle 414 is below 45% of the target duty cycle value, the digital tuning circuit may generate a signal to tune the local DAC down 416 and tune the triggering duty cycle threshold 418 to 55%. Subsequently, the duty cycle-based tuning 401 determines whether the input C2VR duty cycle 414 is above 55% of a target duty cycle value. If the C2VR duty cycle 414 is above 55% of the target duty cycle value, the digital tuning circuit may generate a signal to tune the local DAC up 422 and tune the triggering duty cycle threshold 424 to 55%. If the C2VR duty cycle 414 does not exceed the duty cycle threshold, then no change is made 420 to either the DAC or to the threshold. The tuning of the duty cycle thresholds may be used to provide a duty cycle hysteresis, which allows for a digital tuning circuit to adjust a DAC to enable a stable C2VR voltage output while reducing or minimizing excess switching due to noise. While this duty cycle-based tuning 401 is described with respect to values of 45% and 55%, other levels of duty cycle adjustments may be used to provide a duty cycle hysteresis, such as increasing or decreasing the threshold by 1%, 2%, 10%, 20%, or other duty cycle increments. The duty cycle adjustment level may be selected based on an analysis of noise-induced fluctuations of the C2VR duty cycle or based on a desired C2VR output voltage level accuracy.

FIG. 5 is a diagram illustrating non-dithered output voltage waveforms 500, according to an embodiment. The non-dithered output voltage waveforms 500 show a local output voltage 502 and a remote output voltage 504 without dithering. An expanded portion 510 shows a subset of the local output voltage 502 as it crosses the target voltage value 512. As can be seen in the expanded portion 510, the local output voltage 502 oscillates in time intervals 514 above and below the target voltage value 512. This oscillation (e.g., ripple) above and below the target voltage value 512 is caused by the finite DAC resolution. This ripple effect caused by the finite DAC resolution may be reduced or minimized by applying dithering, as shown in FIG. 6.

FIG. 6 is a diagram illustrating dithered output voltage waveforms 600, according to an embodiment. The dithered output voltage waveforms 600 are generated by application of a dithering DAC input, such as dithering circuit 140 shown in FIG. 1. The upper portion of dithered output voltage waveforms 600 shows the remote comparator output pulse 602 and the average duty cycle translated voltage 604. The lower portion of dithered output voltage waveforms 600 shows the local comparator DAC adjusting waveform 612 and the remote comparator DAC toggling waveform 614. The local comparator DAC adjusting waveform 612 increases in increments, reaching the lower end of the oscillation range of the remote comparator DAC toggling waveform 614 at time 610. The average duty cycle translated voltage 604 increases steadily until time 610. Beginning at time 610, the remote comparator output pulse 602 begins to oscillate between logical zero and logical one values, and the average duty cycle translated voltage 604 reduces steadily toward a target voltage value. In contrast with the oscillating voltage values shown in FIG. 5, the addition of dithering reduces or minimizes this voltage ripple effect, resulting in steady values throughout the average duty cycle translated voltage 604 shown in FIG. 6.

FIG. 7 is a diagram illustrating under-voltage trigger detection waveforms 700, according to an embodiment. The under-voltage trigger detection waveforms 700 shows an under-voltage protection (UVP) trigger waveform 702 and a clock comparator output waveform 704. The UVP trigger waveform 702 may detect an under-voltage event by comparing the direct current (DC) voltage value against an under-protection threshold. In contrast, the clock comparator output waveform 704 may detect an under-voltage event by comparing the voltage value against an under-protection threshold with transient detection information. In an example, a remote sensing circuit may be used to detect a transient signal, and this transient signal detection may become an AC portion of the under-voltage detection threshold, such as the oscillating AC portion of clock comparator output waveform 704 starting at time V1 712.

Each of the UVP trigger waveform 702 and clock comparator output waveform 704 show detection of a droop in the voltage of the remote voltage output 706, such when the remote voltage output 706 falls below voltage droop threshold 722. The clock comparator output waveform 704 shows detection of this voltage droop at time V1 712, when the remote voltage output 706 reaches middle voltage 724. In contrast, the UVP trigger waveform 702 shows detection of this voltage droop at later time V2 714, when the remote voltage output 706 reaches lower voltage 726. By using the AC portion of the transient signal detection, the voltage droop event may be detected using a smaller voltage differential and at an earlier time. This improves the ability of the C2VR circuit to provide early detection for any undervoltage fault or warning.

FIG. 8 is a block diagram illustrating a C2VR analog feedback loop architecture 800, according to an embodiment. The C2VR analog feedback loop architecture 800 shown in FIG. 8 may include an analog signal implementation corresponding to C2VR digital feedback loop architecture 100 shown in FIG. 1.

The C2VR analog feedback loop architecture 800 includes a C2VR PTR 816 coupled to a remote voltage sensing circuit 822 and a local voltage sensing circuit 860. The C2VR analog feedback loop architecture 800 includes a first pair of feedback comparators 848 and 850 coupled to the remote voltage sensing circuit 822. A remote DAC 840 is also coupled to the first pair of feedback comparators 848 and 850. The outputs of the remote voltage sensing circuit 822 and the remote digital to analog converter 842 are coupled alternatingly to either of the first pair of feedback comparators 848 and 850 using a first comparator controller circuit 846 and a first comparator multiplexer 852. Similarly, the C2VR analog feedback loop architecture 800 includes a second pair of feedback comparators 870 and 874 coupled to the local voltage sensing circuit 860. The output of the local voltage sensing circuit 860 and an output of a local DAC 868 are coupled alternatingly to the second pair of feedback comparators 870 and 874 using a second comparator controller circuit 876 and a second comparator multiplexer 872. The first comparator controller circuit 846 and the second comparator controller circuit 876 uses a ping-pong FSM control method to switch between comparators, such as to calibrate the comparator that is not currently coupled to a sensing circuit. The C2VR analog feedback loop architecture 800 may also include a transient detection circuit 802 coupled to the remote voltage sensing circuit 822, which may be used to provide improved detection and alert for any output voltage droop.

The output of the first comparator multiplexer 852 is provided to a first resistor-capacitor (RC) filter 882, which generates a filtered remote DC output. Similarly, the output of the second comparator multiplexer 872 is provided to a second RC filter 884, which generates a filtered local DC output. The filtered remote DC output and filtered local DC output are provided to an analog comparator 864, which compares the two filtered DC outputs. When the analog comparator 864 determines that the filtered remote DC output is greater than the filtered local DC output, this indicates that the DC portion of the first comparator multiplexer 852 is lower than a target voltage value, which may occur when the load is increased and there is a corresponding voltage drop due to that load. When the analog comparator 864 determines that the filtered remote DC output is greater than the filtered local DC output, the analog comparator 864 may send a signal to a DAC code circuit 878, which may be used to increase the code by one least significant bit (LSB) at the local DAC 868, which will cause the output voltage to increase until it reaches the target voltage.

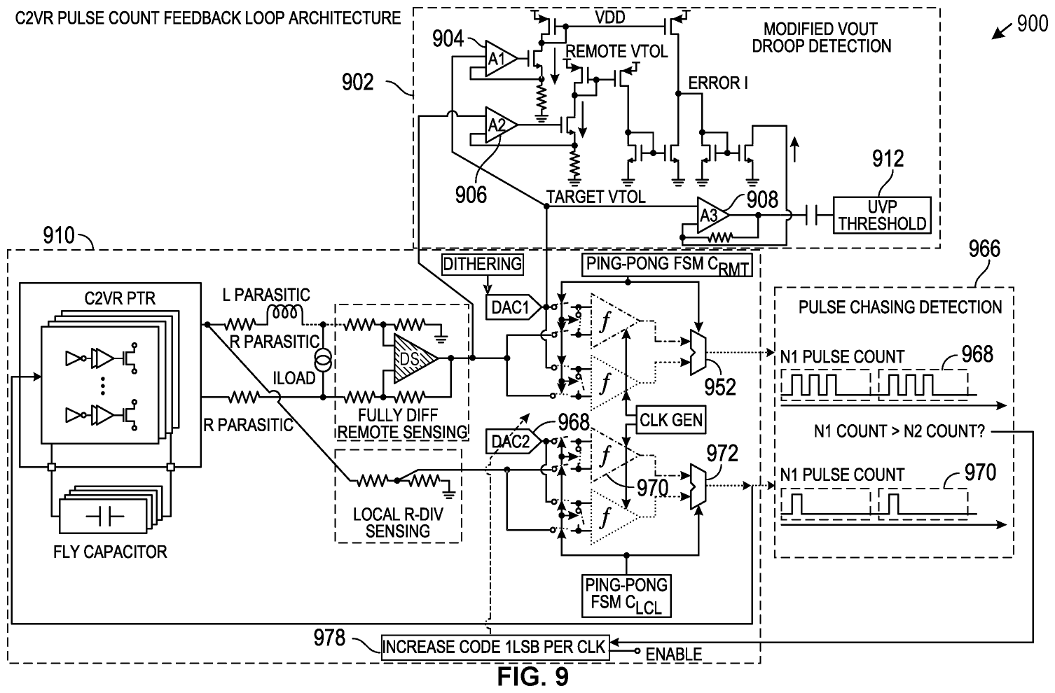

FIG. 9 is a block diagram illustrating a C2VR pulse count feedback loop architecture 900, according to an embodiment. The C2VR pulse count feedback loop architecture 900 shown in FIG. 9 includes several components similar to the C2VR analog feedback loop architecture 800 show in FIG. 8, including common components 910. Unlike the C2VR analog feedback loop architecture 800, the C2VR pulse count feedback loop architecture 900 includes a modified output voltage droop detection circuit 902 and a pulse chasing detection circuit 966.

The modified output voltage droop detection circuit 902 may be used to generate the AC portion of the under-voltage detection threshold, which improves the ability of the C2VR pulse count feedback loop architecture 900 to provide early detection for an under-voltage fault. The modified output voltage droop detection circuit 902 includes a first comparator 904 and coupled to the output of the remote digital to analog converter 842, a second comparator 906 coupled to the remote voltage sensing circuit 822, and a third comparator 908 and coupled to the output of the remote digital to analog converter 842. The output of the third comparator 908 is capacitively coupled to a UVP threshold circuit 912. The UVP threshold circuit 912 may then detect when the remote voltage output falls below a UVP threshold voltage value by detecting the presence of an AC value, such as shown and described with respect to FIG. 7.

The C2VR pulse count feedback loop architecture 900 includes a pulse chasing detection circuit 966. The pulse chasing detection circuit 966 includes a digital circuit that receives the output from the first comparator multiplexer 952 and counts pulses within a first detection window 968. The pulse chasing detection circuit 966 also receives the output from the second comparator multiplexer 972 and counts pulses within a second detection window 970. When the pulse chasing detection circuit 966 determines that the pulse count from the first comparator multiplexer 952 is greater than the pulse count from the second comparator multiplexer 972, the pulse chasing detection circuit 966 may send a signal to a DAC code circuit 978, which may be used to increase the code by one least significant bit (LSB) at the local DAC 868, which in turn will cause the output voltage to increase until it reaches the target voltage.

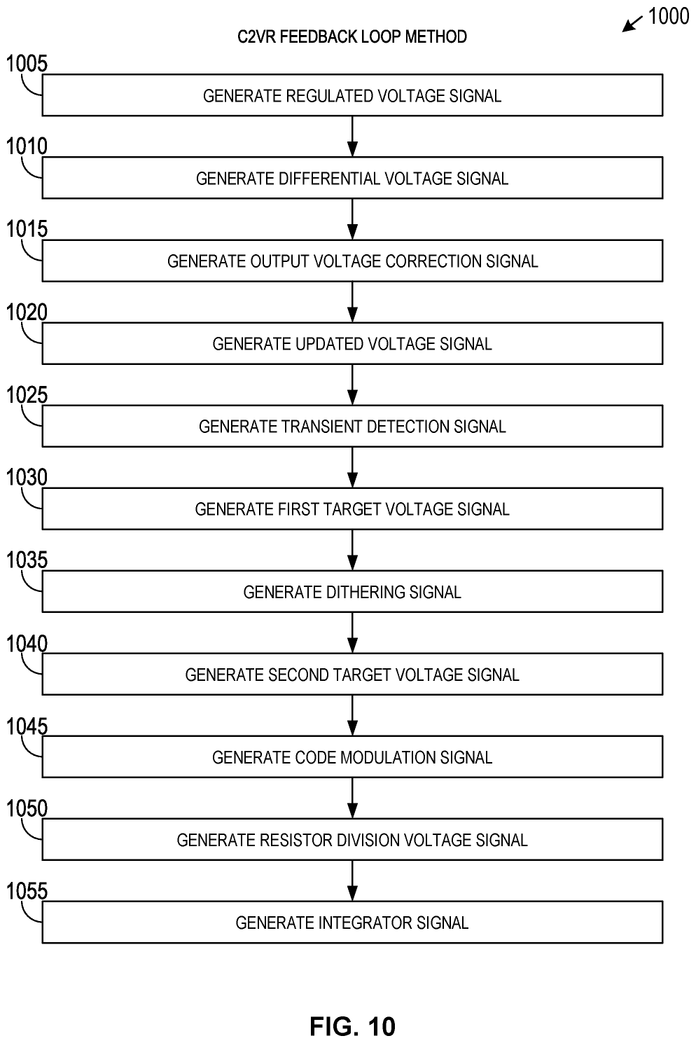

FIG. 10 is a flowchart illustrating a voltage regulation method 1000, according to an embodiment. At step 1005, method 1000 includes generating a regulated voltage signal at a voltage regulator coupled to a load. At step 1010, method 1000 includes generating, at a differential load voltage sensing circuit coupled to an input node of the load and to an output node of the load, a differential voltage signal based on the regulated voltage signal. At step 1015, method 1000 includes generating, at an output voltage sensing circuit coupled to an output pickoff node between the voltage regulator and the load, an output voltage correction signal based on the differential voltage signal and the regulated voltage signal. At step 1020, method 1000 includes generating, at the voltage regulator, an updated voltage signal based on the output voltage correction signal.

At step 1025, method 1000 may further include generating a transient detection signal at a transient detection circuit coupled to the differential load voltage sensing circuit. The generation of the updated voltage signal at the voltage regulator may be further based on the transient detection signal.

At step 1030, method 1000 may further include generating a first target voltage signal at a first digital to analog converter circuit coupled to the differential load voltage sensing circuit. The generation of the differential voltage signal at the differential load voltage sensing circuit may be further based on the first target voltage signal.

At step 1035, method 1000 may further include generating a dithering signal at a dithering circuit coupled to the first digital to analog converter circuit. The generation of the first target voltage signal at the first digital to analog converter circuit may be based on the dithering signal. The differential load voltage sensing circuit includes a first comparator circuit coupled to the differential load voltage sensing circuit and to the first digital to analog converter circuit. The differential voltage signal may be generated at the differential load voltage sensing circuit based on the first target voltage signal and the differential voltage signal.

At step 1040, method 1000 may further include generating a second target voltage signal at a second digital to analog converter circuit. The generation of the output voltage correction signal at the differential load voltage sensing circuit may be further based on the second target voltage signal.

At step 1045, method 1000 may further include generating a code modulation signal based on the differential voltage signal at a code modulation circuit. The generation of the second target voltage signal may be further based on the code modulation signal.

At step 1050, method 1000 may further include generating a resistor division voltage signal at a resistor division sensing circuit coupled to the output pickoff node. The output voltage sensing circuit includes a first comparator to generate the output voltage correction signal based on the second target voltage signal and the resistor division voltage signal. The differential load voltage sensing circuit further includes a first calibration control circuit and a second remote comparator. The first calibration control circuit may be configured to oscillate the differential voltage signal and the first target voltage signal between the first comparator circuit and the second remote comparator. The resistor division sensing circuit further includes a second calibration control circuit and a second comparator. The second calibration control circuit may be configured to oscillate the differential voltage signal and the first target voltage signal between the first comparator and the second comparator.

At step 1055, method 1000 may further include generating an integrator signal at an integrator circuit based on the differential voltage signal. The generation of the updated voltage signal at the voltage regulator may be further based on a comparison between the output voltage correction signal and the integrator signal.

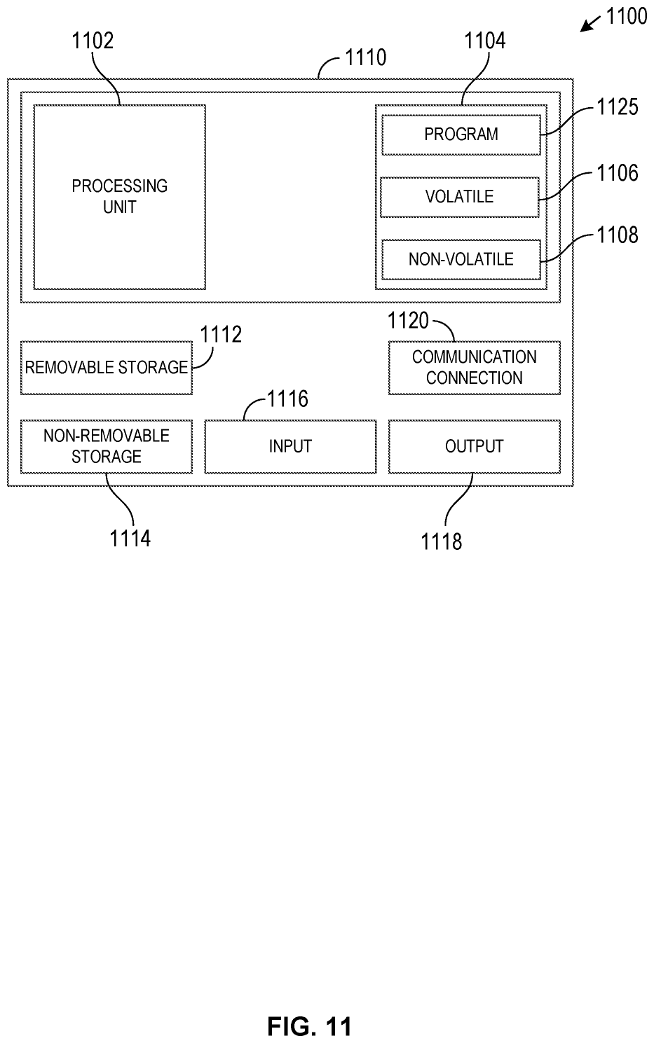

FIG. 11 is a block diagram of a computing device 1100 employing parallel current source voltage regulation, according to an embodiment. The performance of one or more components within computing device 1100 may be improved by including one or more of the circuits or circuitry methods described herein. Computing device 1100 may include a load voltage sensing circuit to generate a load voltage correction signal based on a received regulated voltage signal, an output voltage sensing circuit to generate an output voltage correction signal based on the load voltage correction signal, and a voltage regulator to generate an updated voltage signal based on the load voltage correction signal.

In one embodiment, multiple such computer systems are used in a distributed network to implement multiple components in a transaction-based environment. An object-oriented, service-oriented, or other architecture may be used to implement such functions and communicate between the multiple systems and components. In some embodiments, the computing device of FIG. 11 is an example of a client device that may invoke methods described herein over a network. In some embodiments, the computing device of FIG. 11 is an example of one or more of the personal computer, smartphone, tablet, or various servers.

One example computing device in the form of a computer 1110, may include a processing unit 1102, memory 1104, removable storage 1112, and non-removable storage 1114. Although the example computing device is illustrated and described as computer 1110, the computing device may be in different forms in different embodiments. For example, the computing device may instead be a smartphone, a tablet, or other computing device including the same or similar elements as illustrated and described with regard to FIG. 11. Further, although the various data storage elements are illustrated as part of the computer 1110, the storage may include cloud-based storage accessible via a network, such as the Internet.

Returning to the computer 1110, memory 1104 may include volatile memory 1106 and non-volatile memory 1108. Computer 1110 may include or have access to a computing environment that includes a variety of computer-readable media, such as volatile memory 1106 and non-volatile memory 1108, removable storage 1112 and non-removable storage 1114. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1110 may include or have access to a computing environment that includes input 1116, output 1118, and a communication connection 1120. The input 1116 may include one or more of a touchscreen, touchpad, mouse, keyboard, camera, and other input devices. The input 1116 may include a navigation sensor input, such as a GNSS receiver, a SOP receiver, an inertial sensor (e.g., accelerometers, gyroscopes), a local ranging sensor (e.g., LIDAR), an optical sensor (e.g., cameras), or other sensors. The computer may operate in a networked environment using a communication connection 1120 to connect to one or more remote computers, such as database servers, web servers, and another computing device. An example remote computer may include a personal computer (PC), server, router, network PC, a peer device or other common network node, or the like. The communication connection 1120 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 1102 of the computer 1110. A hard drive (magnetic disk or solid state), CD-ROM, and RAM are some examples of articles including a non-transitory computer-readable medium. For example, various computer programs 1125 or apps, such as one or more applications and modules implementing one or more of the methods illustrated and described herein or an app or application that executes on a mobile device or is accessible via a web browser, may be stored on a non-transitory computer-readable medium.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Each of the following non-limiting examples may stand on its own, or may be combined in various permutations or combinations with one or more of the other examples.

Example 1 is an apparatus comprising: a voltage regulator coupled to a load, the voltage regulator to generate a regulated voltage signal and provide the regulated voltage signal to the load; a load voltage sensing circuit coupled to an input node of the load and to an output node of the load, the load voltage sensing circuit to generate a differential voltage signal based on the regulated voltage signal; and an output voltage sensing circuit coupled to an output node between the voltage regulator and the load, the output voltage sensing circuit to generate an output voltage correction signal based on the differential voltage signal and the regulated voltage signal; wherein the voltage regulator is further to generate an updated voltage signal based on the output voltage correction signal.

In Example 2, the subject matter of Example 1 includes a transient detection circuit coupled to the load voltage sensing circuit, the transient detection circuit to generate a transient detection signal, wherein the generation of the updated voltage signal at the voltage regulator is further based on the transient detection signal.

In Example 3, the subject matter of Example 2 includes a first digital to analog converter circuit coupled to the load voltage sensing circuit, the first digital to analog converter circuit to generate a first target voltage signal, wherein the generation of the differential voltage signal at the load voltage sensing circuit is further based on the first target voltage signal.

In Example 4, the subject matter of Example 3 includes a dithering circuit coupled to the first digital to analog converter circuit, the dithering circuit to generate a dithering signal, wherein the generation of the first target voltage signal at the first digital to analog converter circuit is based on the dithering signal.

In Example 5, the subject matter of Examples 3-4 includes wherein the load voltage sensing circuit includes a first comparator circuit coupled to the load voltage sensing circuit and to the first digital to analog converter circuit, the load voltage sensing circuit to generate the differential voltage signal based on the first target voltage signal and the differential voltage signal.

In Example 6, the subject matter of Example 5 includes a second digital to analog converter circuit to generate a second target voltage signal, wherein the generation of the output voltage correction signal at the load voltage sensing circuit is further based on the second target voltage signal.

In Example 7, the subject matter of Example 6 includes a code modulation circuit to generate a code modulation signal based on the differential voltage signal, wherein the generation of the second target voltage signal is further based on the code modulation signal.

In Example 8, the subject matter of Examples 6-7 includes a resistor division sensing circuit coupled to the output node, the resistor division sensing circuit to generate a resistor division voltage signal, wherein the output voltage sensing circuit includes a first comparator to generate the output voltage correction signal based on the second target voltage signal and the resistor division voltage signal.

In Example 9, the subject matter of Example 8 includes wherein the load voltage sensing circuit further includes a first calibration control circuit and a second remote comparator, the first calibration control circuit to oscillate the differential voltage signal and the first target voltage signal between the first comparator circuit and the second remote comparator.

In Example 10, the subject matter of Example 9 includes wherein the resistor division sensing circuit further includes a second calibration control circuit and a second comparator, the second calibration control circuit to oscillate the differential voltage signal and the first target voltage signal between the first comparator and the second comparator.

In Example 11, the subject matter of Examples 1-10 includes an integrator circuit to generate an integrator signal based on the differential voltage signal generated at the load voltage sensing circuit, wherein the generation of the updated voltage signal at the voltage regulator is further based on a comparison between the output voltage correction signal and the integrator signal.

In Example 12, the subject matter of Examples 1-11 includes wherein: the load includes a processor; the apparatus further includes the processor and a processor power supply; and the processor power supply includes the voltage regulator, the load voltage sensing circuit, and the output voltage sensing circuit.

In Example 13, the subject matter of Examples 1-12 includes wherein: the load includes a memory device; the apparatus further includes the memory device and a memory power supply; and the memory power supply includes the voltage regulator, the load voltage sensing circuit, and the output voltage sensing circuit.

In Example 14, the subject matter of Examples 1-13 includes wherein: the load includes a communication interface, the communication interface conforming with at least one of Universal Serial Bus (USB), High-Definition Multimedia Interface (HDMI), Thunderbolt, Peripheral Component Interconnect Express (PCIe), or Ethernet specifications; the apparatus further includes the communication interface and a communication power supply; and the communication power supply includes the voltage regulator, the load voltage sensing circuit, and the output voltage sensing circuit.

Example 15 is a method comprising: generating a regulated voltage signal at a voltage regulator coupled to a load; generating, at a load voltage sensing circuit coupled to an input node of the load and to an output node of the load, a differential voltage signal based on the regulated voltage signal; generating, at an output voltage sensing circuit coupled to an output node between the voltage regulator and the load, an output voltage correction signal based on the differential voltage signal and the regulated voltage signal; and generating, at the voltage regulator, an updated voltage signal based on the output voltage correction signal.

In Example 16, the subject matter of Example 15 includes generating a transient detection signal at a transient detection circuit coupled to the load voltage sensing circuit, wherein the generation of the updated voltage signal at the voltage regulator is further based on the transient detection signal.

In Example 17, the subject matter of Example 16 includes generating a first target voltage signal at a first digital to analog converter circuit coupled to the load voltage sensing circuit, wherein the generation of the differential voltage signal at the load voltage sensing circuit is further based on the first target voltage signal.

In Example 18, the subject matter of Example 17 includes generating a dithering signal at a dithering circuit coupled to the first digital to analog converter circuit, wherein the generation of the first target voltage signal at the first digital to analog converter circuit is based on the dithering signal.

In Example 19, the subject matter of Examples 17-18 includes wherein: the load voltage sensing circuit includes a first comparator circuit coupled to the load voltage sensing circuit and to the first digital to analog converter circuit; and the differential voltage signal is generated at the load voltage sensing circuit based on the first target voltage signal and the differential voltage signal.

In Example 20, the subject matter of Example 19 includes generating a second target voltage signal at a second digital to analog converter circuit, wherein the generation of the output voltage correction signal at the load voltage sensing circuit is further based on the second target voltage signal.

In Example 21, the subject matter of Example 20 includes generating a code modulation signal based on the differential voltage signal at a code modulation circuit, wherein the generation of the second target voltage signal is further based on the code modulation signal.

In Example 22, the subject matter of Examples 20-21 includes generating a resistor division voltage signal at a resistor division sensing circuit coupled to the output node, wherein the output voltage sensing circuit includes a first comparator to generate the output voltage correction signal based on the second target voltage signal and the resistor division voltage signal.

In Example 23, the subject matter of Example 22 includes wherein: the load voltage sensing circuit further includes a first calibration control circuit and a second remote comparator; and the first calibration control circuit is configured to oscillate the differential voltage signal and the first target voltage signal between the first comparator circuit and the second remote comparator.

In Example 24, the subject matter of Example 23 includes wherein: the resistor division sensing circuit further includes a second calibration control circuit and a second comparator; and the second calibration control circuit is configured to oscillate the differential voltage signal and the first target voltage signal between the first comparator and the second comparator.

In Example 25, the subject matter of Examples 15-24 includes generating an integrator signal at an integrator circuit based on the differential voltage signal, wherein the generation of the updated voltage signal at the voltage regulator is further based on a comparison between the output voltage correction signal and the integrator signal.

Example 26 is a circuit comprising: a capacitive voltage regulator coupled to a load, the capacitive voltage regulator to generate a regulated voltage signal and provide the regulated voltage signal to the load; a first voltage sensing circuit coupled to an input node of the load and to an output node of the load, the first voltage sensing circuit to generate a remote sensing voltage signal based on the regulated voltage signal; and a second voltage sensing circuit coupled to receive the regulated voltage signal at an output node between the capacitive voltage regulator and the load, the second voltage sensing circuit to generate an output voltage correction signal based on the remote sensing voltage signal and the regulated voltage signal; wherein the capacitive voltage regulator is further to generate an updated voltage signal based on the output voltage correction signal.

In Example 27, the subject matter of Example 26 includes wherein the first voltage sensing circuit includes a load voltage sensing circuit to generate a differential voltage signal based on the regulated voltage signal, wherein the remote sensing voltage signal is based on the differential voltage signal.

In Example 28, the subject matter of Examples 26-27 includes a transient detection circuit coupled to the first voltage sensing circuit, the transient detection circuit to generate a transient detection signal, wherein the generation of the updated voltage signal at the capacitive voltage regulator is further based on the transient detection signal.

In Example 29, the subject matter of Example 28 includes a first digital to analog converter circuit coupled to the first voltage sensing circuit, the first digital to analog converter circuit to generate a first target voltage signal, wherein the generation of the remote sensing voltage signal at the first voltage sensing circuit is further based on the first target voltage signal.

In Example 30, the subject matter of Example 29 includes a dithering circuit coupled to the first digital to analog converter circuit, the dithering circuit to generate a dithering signal, wherein the generation of the first target voltage signal at the first digital to analog converter circuit is based on the dithering signal.

In Example 31, the subject matter of Examples 29-30 includes wherein the first voltage sensing circuit includes a first comparator circuit coupled to the first voltage sensing circuit and to the first digital to analog converter circuit, the first voltage sensing circuit to generate the remote sensing voltage signal based on the first target voltage signal and the remote sensing voltage signal.

In Example 32, the subject matter of Example 31 includes a second digital to analog converter circuit to generate a second target voltage signal, wherein the generation of the output voltage correction signal at the first voltage sensing circuit is further based on the second target voltage signal.

In Example 33, the subject matter of Example 32 includes a code modulation circuit to generate a code modulation signal based on the remote sensing voltage signal, wherein the generation of the second target voltage signal is further based on the code modulation signal.

In Example 34, the subject matter of Examples 32-33 includes a resistor division sensing circuit coupled to the output node, the resistor division sensing circuit to generate a resistor division voltage signal, wherein the second voltage sensing circuit includes a first comparator to generate the output voltage correction signal based on the second target voltage signal and the resistor division voltage signal.

In Example 35, the subject matter of Example 34 includes wherein the first voltage sensing circuit further includes a first calibration control circuit and a second remote comparator, the first calibration control circuit to oscillate the remote sensing voltage signal and the first target voltage signal between the first comparator circuit and the second remote comparator.

In Example 36, the subject matter of Example 35 includes wherein the resistor division sensing circuit further includes a second calibration control circuit and a second comparator, the second calibration control circuit to oscillate the remote sensing voltage signal and the first target voltage signal between the first comparator and the second comparator.

In Example 37, the subject matter of Examples 26-36 includes an integrator circuit to generate an integrator signal based on the remote sensing voltage signal generated at the first voltage sensing circuit, wherein the generation of the updated voltage signal at the capacitive voltage regulator is further based on a comparison between the output voltage correction signal and the integrator signal.

Example 38 is at least one machine-readable medium including instructions that, when executed by processing circuitry, cause the processing circuitry to perform operations to implement of any of Examples 1-37.

Example 39 is an apparatus comprising means to implement of any of Examples 1-37.

Example 40 is a system to implement of any of Examples 1-37.

Example 41 is a method to implement of any of Examples 1-37.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described.

However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An apparatus comprising:
a voltage regulator coupled to a load, the voltage regulator to generate a regulated voltage signal and provide the regulated voltage signal to the load;
a load voltage sensing circuit coupled to an input node of the load and to an output node of the load, the load voltage sensing circuit to generate a differential voltage signal based on the regulated voltage signal; and
an output voltage sensing circuit coupled to an output node between the voltage regulator and the load, the output voltage sensing circuit to generate an output voltage correction signal based on the differential voltage signal and the regulated voltage signal;
wherein the voltage regulator is further to generate an updated voltage signal based on the output voltage correction signal.

2. The apparatus of claim 1, further including a transient detection circuit coupled to the load voltage sensing circuit, the transient detection circuit to generate a transient detection signal, wherein the generation of the updated voltage signal at the voltage regulator is further based on the transient detection signal.

3. The apparatus of claim 2, further including a first digital to analog converter circuit coupled to the load voltage sensing circuit, the first digital to analog converter circuit to generate a first target voltage signal, wherein the generation of the differential voltage signal at the load voltage sensing circuit is further based on the first target voltage signal.

4. The apparatus of claim 3, further including a dithering circuit coupled to the first digital to analog converter circuit, the dithering circuit to generate a dithering signal, wherein the generation of the first target voltage signal at the first digital to analog converter circuit is based on the dithering signal.

5. The apparatus of claim 3, wherein the load voltage sensing circuit includes a first comparator circuit coupled to the load voltage sensing circuit and to the first digital to analog converter circuit, the load voltage sensing circuit to generate the differential voltage signal based on the first target voltage signal and the differential voltage signal.

6. The apparatus of claim 5, further including a second digital to analog converter circuit to generate a second target voltage signal, wherein the generation of the output voltage correction signal at the load voltage sensing circuit is further based on the second target voltage signal.

7. The apparatus of claim 6, further including a resistor division sensing circuit coupled to the output node, the resistor division sensing circuit to generate a resistor division voltage signal, wherein the output voltage sensing circuit includes a first comparator to generate the output voltage correction signal based on the second target voltage signal and the resistor division voltage signal.

8. The apparatus of claim 1, further including an integrator circuit to generate an integrator signal based on the differential voltage signal generated at the load voltage sensing circuit, wherein the generation of the updated voltage signal at the voltage regulator is further based on a comparison between the output voltage correction signal and the integrator signal.

9. The apparatus of claim 1, wherein:
the load includes a processor;
the apparatus further includes the processor and a processor power supply; and
the processor power supply includes the voltage regulator, the load voltage sensing circuit, and the output voltage sensing circuit.

10. The apparatus of claim 1, wherein:
the load includes a memory device;
the apparatus further includes the memory device and a memory power supply; and
the memory power supply includes the voltage regulator, the load voltage sensing circuit, and the output voltage sensing circuit.

11. The apparatus of claim 1, wherein:
the load includes a communication interface, the communication interface conforming with at least one of Universal Serial Bus (USB), High-Definition Multimedia Interface (HDMI), Thunderbolt, Peripheral Component Interconnect Express (PCIe), or Ethernet specifications;
the apparatus further includes the communication interface and a communication power supply; and
the communication power supply includes the voltage regulator, the load voltage sensing circuit, and the output voltage sensing circuit.

12. A method comprising:
generating a regulated voltage signal at a voltage regulator coupled to a load;
generating, at a load voltage sensing circuit coupled to an input node of the load and to an output node of the load, a differential voltage signal based on the regulated voltage signal;
generating, at an output voltage sensing circuit coupled to an output node between the voltage regulator and the load, an output voltage correction signal based on the differential voltage signal and the regulated voltage signal; and
generating, at the voltage regulator, an updated voltage signal based on the output voltage correction signal.

13. The method of claim 12, further including generating a transient detection signal at a transient detection circuit coupled to the load voltage sensing circuit, wherein the generation of the updated voltage signal at the voltage regulator is further based on the transient detection signal.

14. The method of claim 13, further including generating a first target voltage signal at a first digital to analog converter circuit coupled to the load voltage sensing circuit, wherein the generation of the differential voltage signal at the load voltage sensing circuit is further based on the first target voltage signal.

15. The method of claim 14, further including generating a dithering signal at a dithering circuit coupled to the first digital to analog converter circuit, wherein the generation of the first target voltage signal at the first digital to analog converter circuit is based on the dithering signal.

16. The method of claim 14, wherein:
the load voltage sensing circuit includes a first comparator circuit coupled to the load voltage sensing circuit and to the first digital to analog converter circuit; and
the differential voltage signal is generated at the load voltage sensing circuit based on the first target voltage signal and the differential voltage signal.

17. The method of claim 16, further including generating a second target voltage signal at a second digital to analog converter circuit, wherein the generation of the output voltage correction signal at the load voltage sensing circuit is further based on the second target voltage signal.

18. A circuit comprising:
a capacitive voltage regulator coupled to a load, the capacitive voltage regulator to generate a regulated voltage signal and provide the regulated voltage signal to the load;
a first voltage sensing circuit coupled to an input node of the load and to an output node of the load, the first voltage sensing circuit to generate a remote sensing voltage signal based on the regulated voltage signal; and
a second voltage sensing circuit coupled to receive the regulated voltage signal at an output node between the capacitive voltage regulator and the load, the second voltage sensing circuit to generate an output voltage correction signal based on the remote sensing voltage signal and the regulated voltage signal;
wherein the capacitive voltage regulator is further to generate an updated voltage signal based on the output voltage correction signal.

19. The circuit of claim 18, wherein the first voltage sensing circuit includes a load voltage sensing circuit to generate a differential voltage signal based on the regulated voltage signal, wherein the remote sensing voltage signal is based on the differential voltage signal.

20. The circuit of claim 18, further including a transient detection circuit coupled to the first voltage sensing circuit, the transient detection circuit to generate a transient detection signal, wherein the generation of the updated voltage signal at the capacitive voltage regulator is further based on the transient detection signal.
